(19) United States
(12) Patent Application Publication
(10) Pub. No.: US 2007/0180167 A1
(43) Pub. Date: Aug. 2, 2007

(54) Dynamic partition mapping in a hot-pluggable data storage apparatus

(75) Inventors: SzeChek Tan, Singapore (SG); WenXiang Xie, Singapore (SG); YewMeng Tan, Singapore (SG); WeiLoon Ng, Singapore (SG)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402-3319, US

(73) Assignee: Seagate Technology LLC, Scotts Valley, CA (US)

(21) Appl. No.: 11/345,913

(22) Filed: Feb. 2, 2006

(51) Int. Cl. G06F 13/12

(52) U.S. Cl. 710/74

(57) ABSTRACT

An apparatus includes a partitionable data storage medium and control electronics. The control electronics includes a hot-pluggable connection with a bus. The control electronics receives a RESET command from a host while the bus is energized, and dynamically re-maps the data storage medium to provide M active partitions, where M is dynamically controllable by the host.

### FIELD OF THE INVENTION

The present invention relates generally to hot-pluggable data storage apparatus, and more particularly by not by limitation to hot-pluggable data storage apparatus that is energizable by power supplied by a bus.

### BACKGROUND OF THE INVENTION

Hot-pluggable data storage drives that connect to a universal serial bus (USB) are known. The term “hot pluggable” refers to a bus connectable data storage device that can be connected to a host computer after the host computer has finished booting up from an off state. With hot-pluggable data storage devices, there is no need to reboot a host computer after completing the bus connection in order for the host computer to access data on the data storage drive. Some of these hot-pluggable drives can be partitioned into a fixed number of multiple partitions. The number of available partitions is preset or fixed during manufacture, can't be changed by a user, and is usually a relatively small number. After plugging into a USB bus, the hot-pluggable data storage device replies to a GetMaxLUN command from the host by providing a LUN=N command indicating the number of partitions created. If LUN=0, there is only one partition created. If LUN=1, there are two partitions created. If LUN=2 there are three partitions created.

It is also possible for one of the partitions to be public and another (secure) partition to be hidden and protected by a password. Typically, the operating system does not display the secure partition to the user until the user offers a correct password. If an unauthorized user gains physical access to the storage device, the unauthorized user may not be aware of the secure partition and overlook it. If the unauthorized user is aware of the possibility of a secure partition, however, he may be able to access data in the secure partition by repeatedly trying passwords (attacking security) until the correct password is hit upon. This attack is easily automated and is likely to result in access to secure data in a period of time that is short enough so that the data access is of value to the unauthorized user.

There is a desire to improve hot-pluggable storage devices so that the length of time needed to gain access to sensitive data in a hidden partition becomes so unreasonably long that the data loses most or all of its value to an unauthorized user.

Embodiments of the present invention provide solutions to these and other problems, and offer other advantages over the prior art.

### SUMMARY OF THE INVENTION

Disclosed is an apparatus. The apparatus comprises a data storage medium that stores data and is partitionable. The apparatus comprises control electronics.

The control electronics includes a hot-pluggable connection with a bus. The control electronics receives a command from a host while the bus is energized. Responsive to the command, the control electronics dynamically re-maps the storage drive to provide a selected number M of active partitions, where the selected number M is dynamically controllable by the host.

Other features and benefits that characterize embodiments of the present inventions will be apparent upon reading the following detailed description and review of the associated drawings.

### BRIEF DESCRIPTION OF THE DRAWINGS

FIG. 1 is an isometric view of a disc drive.

FIG. 2 illustrates a data storage apparatus with control electronics connected by a cable to a host computer system.

FIG. 3 illustrates a data storage apparatus with control electronics.

FIG. 4 illustrates a timing diagram of communication activity on a bus connected to a hot-pluggable control electronics connecting to a data storage medium.

FIG. 5 illustrates a first sequence of communication activities on a bus as a data storage apparatus is plugged in, a secure partition is accessed and removed from access.

FIGS. 6-9 illustrate a second sequence of communication activities on a bus as a data storage apparatus is plugged into a first host, the data storage apparatus is resized from two to three partitions, a login is made to a second partition, and then the data storage apparatus is unplugged from the first host and then hot-plugged into a second host.

### DETAILED DESCRIPTION OF ILLUSTRATIVE EMBODIMENTS

When a data storage apparatus is connected to a host via a USB bus, the host senses the connection and provides power-on RESET and GetMaxLUN commands to the hot-pluggable storage device. The storage apparatus replies to the GetMaxLUN command with a command LUN=N. “N” represents the maximum LUN number of storage partitions that are available to the host. The number “N” is fixed by the design of the USB storage device. The GetMaxLUN command and the LUN=N command are part of an “OS Enumerate USB Device” command exchange between the host and the storage device.

When N=0 there is a single partition, in other words the hot-pluggable USB storage device is designed with a single partition, and in a conventional drive, a second partition can't be created.

When N=1, there are two available partitions, and the user can partition the hot-pluggable USB storage device and allocate the storage capacity of the drive between the two partitions. The two partitions are then separately displayed to the user, for example, as D:/ and E:/ in a Windows operating system. The number N is conventionally Ha fixed number that is a feature of the design of a particular hot-pluggable USB storage device;

In the embodiments described below, hot-pluggable storage apparatus is disclosed in which the length of time needed to gain unauthorized access to sensitive data in a hidden partition is made longer by use of control electronics. The LUN is made dynamically changeable, and an attacker is faced with the possibility of a large, unknown number of partitions that have been created. The time to test passwords for all the possible partitions becomes so unreasonably long that, in many cases, it takes so long to access the data that the data loses most or all of its value to an unauthorized user.

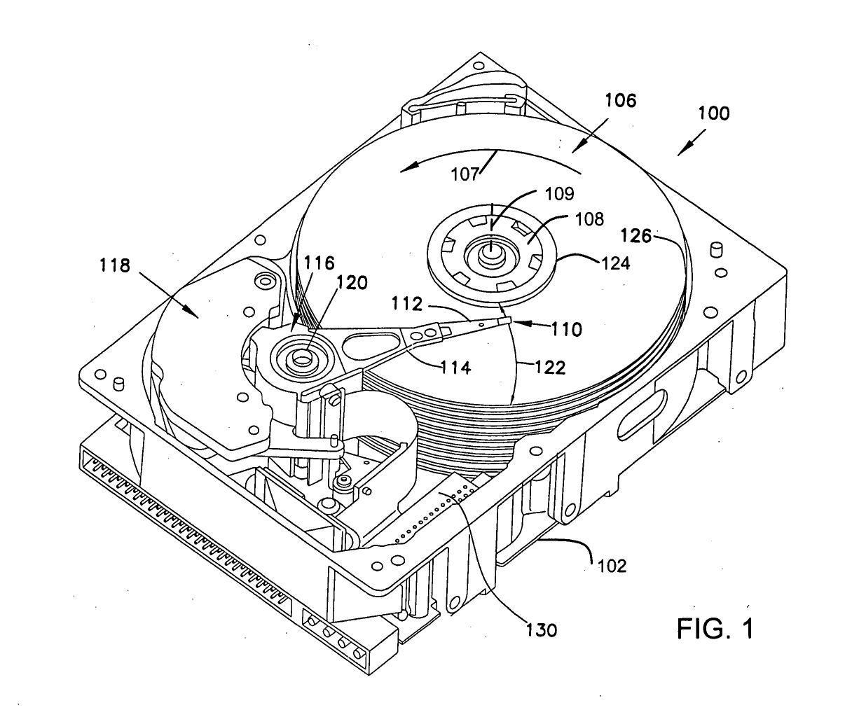

FIG. 1 is an isometric view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation about central axis 109. Each disc surface has an associated disc head slider 110 which is mounted to disc drive 100 for communication with the disc surface. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

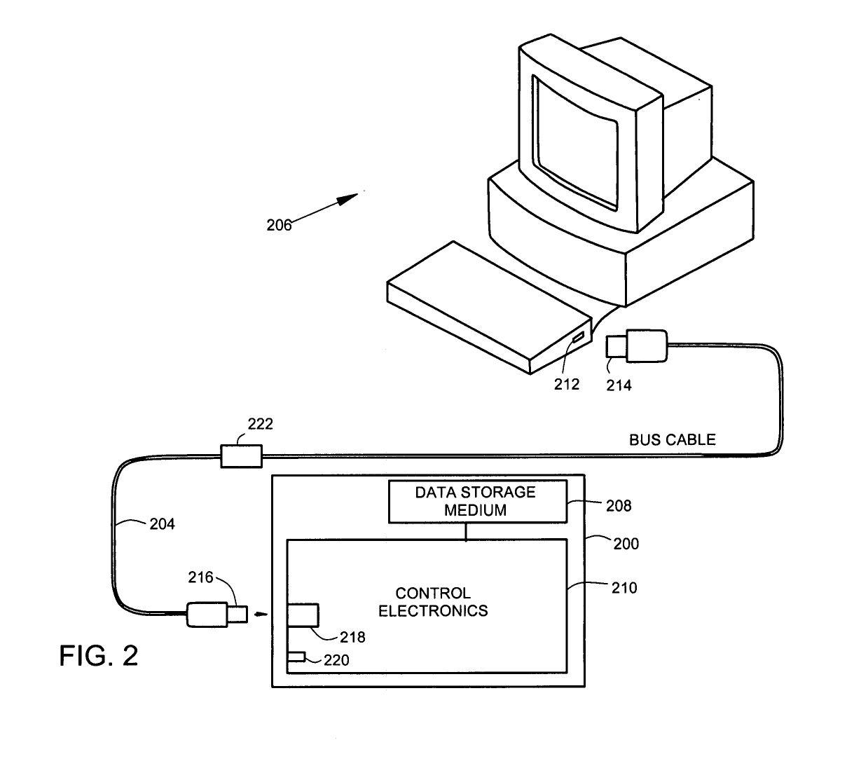

FIG. 2 illustrates an data storage apparatus 200 that connects via a bus cable 204 to a host computing system 206. The data storage apparatus 200 comprises a data storage medium 208 (such as, for example, the disc drive 100 in FIG. 1) that couples to control electronics 210. The control electronics 210 couples to the bus cable 204. The control electronics 210 is typically housed in the same housing with the data storage apparatus 200. The arrangement is especially useful for a pocket sized hot-pluggable portable disc drive that is energized by the bus cable 204. The bus cable 204 can be a universal serial bus,(USB), firewire, or other bus that supports hot-pluggable data storage apparatus.

The host computing system 206 can comprise a desktop computer (as illustrated), a laptop computer or a network of computers. The host computing system 206 includes an operating system that includes capability to interface with apparatus such as an internal disc drive (not illustrated) or a hot-pluggable data storage apparatus such as apparatus 200. The host computing system 206 also includes hardware and software (a host bus controller) supporting a bus interface protocol (such as USB, Firewire or other bus protocol) which is accessible at a bus socket 212. The bus socket 212 can be on a keyboard (as illustrated), on a display monitor, on a computer, on a bus hub or on other known locations for bus sockets on a host computing system. The bus socket 212 is of conventional design and, in preferred embodiments, includes two conductors that carry power and two conductors that carry bidirectional serial digital communication according to the bus protocol. The bus protocol includes a subset of communication commands that are useful for interfacing between the apparatus 200 and the host operating system.

The bus cable 204 includes at least two power conductors, at least two communication conductors and one or more optional shield conductors, depending on the needs of the application. The bus cable 204 includes a standard bus plug 214 that plugs into the bus socket 212 on the host. The bus cable 204 includes a bus connector 216, and the bus connector 216 is typically a miniature type of bus connector that plugs into a corresponding miniature bus socket 218 on the apparatus 200. The apparatus 200 can also be configured to integrally include the bus cable 204 and bus plug 214, in which case the connectors 216, 218 are not used and the bus cable 204 is hard-wired to the control electronics 210. The bus cable 204 can have various lengths up to 5 meters, but typically has a length of about 0.5 meters or less. The bus cable 204 can include an optional ferrite core or block of magnetic material 222 for suppressing conduction of noise along the bus cable 204. In one embodiment, the host computing system 206 supplies power via the bus cable 204 to the apparatus 200. In another embodiment, the apparatus 200 obtains power from a separate power connector 220. The separate power connector 220 can connect to a separate transformer supply or to a power outlet on the host 206. The apparatus 200 can also include a battery (not illustrated) that provides power to the apparatus 200.

In each of these embodiments, however, the bus power conductors are energized ace by the host, and the control electronics 210 senses connection and disconnection of bus power in the bus cable. This sensing of power on the bus power conductors enables the control electronics 210 to distinguish between a physical plugging and unplugging of the USB cable on the one hand, and a simulated or “soft” reset command that is communicated from the operating system via the bus communication conductors on the other hand. The control electronics 210 interacts with the operating system of the host to establish partitions of the storage drive 208 as described in more detail in specific examples described below.

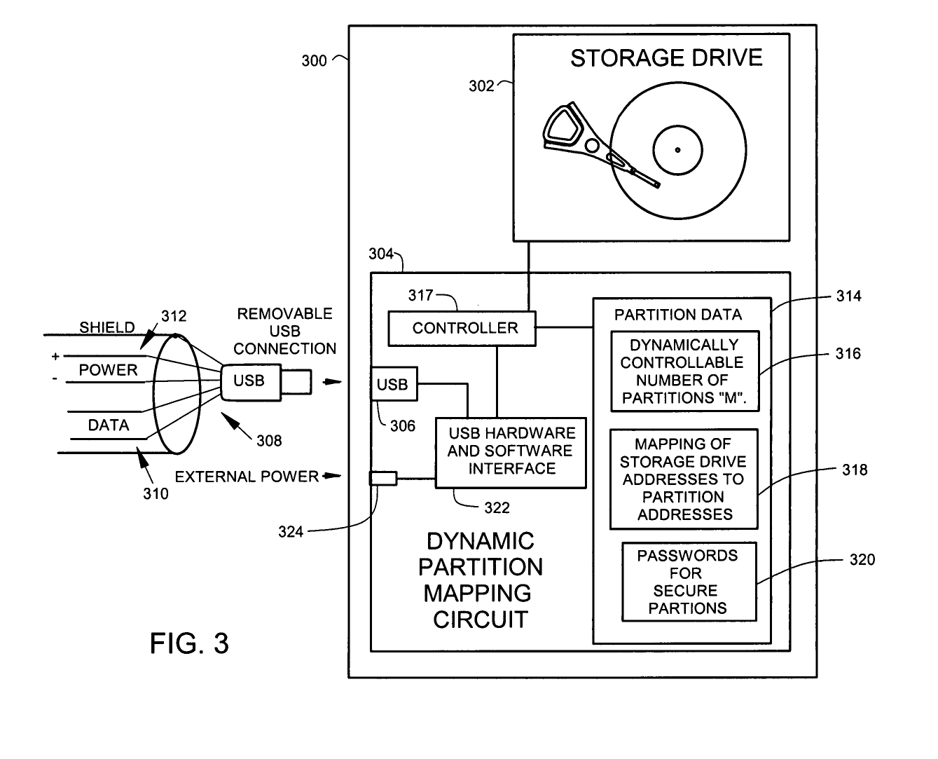

FIG. 3 illustrates an apparatus 300. The apparatus 300 comprises a storage drive 302 that is partitionable. Partitioning is a process that is controlled by a user. The user allocates or segments portions of the apparatus into partitions that are distinguishable from one another in terms of logical addressing by the host computer.

The user may elect to partition the storage drive 302 for a variety of reasons. One partition may be used for storage of files associated with a first host operating system, and another partition may be used for storage of files associated with a second host operating system. Alternatively, a first partition may be used for storage of device drivers, operating system and applications, while a second partition is used for files created by the user such as word processor files, graphics files, spreadsheets, database files and other user files. A partition may also be created by the user that is hidden in the sense that the user interface of the host does not display the hidden partition to the user unless a password is entered by the user. At the user interface on the host, drive partitions are typically displayed to the user as separate drive letters such as C: , E: , F: and so forth. Drive letters for hidden partitions are not displayed to the user until after the user provides a password.

The apparatus 300 comprises control electronics 304. The control electronics 304 comprises a hot-pluggable USB connection 306 to a USB bus 308 that connects to a host (not illustrated in FIG. 3). The control electronics 304 receives a RESET command (via data lines 310 from the host) during a time that the control electronics 304 senses uninterrupted power from the host on the power conductors 312 of the USB bus 308. In response to the RESET command and subsequent user commands during a time of uninterrupted power from the host, the control electronics 304 dynamically re-maps the storage drive 302 to provide a number M of active partitions. The number M is dynamically controllable by the host via serial digital communication on the data lines 310.

The control electronics 304 comprises partition data 314 that is dynamically changeable. The partition data 314 can be stored in electronic memory that is nonvolatile and rewriteable, or the partition data 314 can be stored on the storage drive 302 and loaded into electronic volatile memory (such as RAM) by command of a controller 317 that is part of the control electronics 304. The partition data 314 comprises the number “M” 316 of active partitions that are selected by the user. The partition data 314 comprises a mapping 318 of physical drive addresses of storage drive 302 to logical partition addresses on the host as defined by the user. The partition data 314 comprises passwords 320 for accessing secure hidden partitions. The passwords 320 can be provided via the USB bus 308. Alternatively, the passwords can be provided from a biometric reader (such as a fingerprint or iris scanner) that is located on the storage apparatus 300 or on some part of the host computer system.

The hot-pluggable USB connection 306 couples to a USB hardware and software interface circuit (storage device USB controller) 322. The USB hardware and software interface circuit 322 couples to the controller 317 to communicate power and bidirectional commands carried via the USB bus 308. An external power connector 324 can be used to provide power when the host is not capable of providing enough power to energize the apparatus 300.

In one embodiment, the dynamic number M is a function of a dynamic logical unit S number (LUN) stored by the control electronics 304 in the partition data 314. The number M is preferably not displayed to the user unless a password is provided first. The dynamic setting of M is resettable after receipt of the RESET command and a password while the USB bus is continuously energized.

The number M is typically settable at least in the range of 1 to 200. This increases by a factor of about 200 the number of passwords that must be tried by an attacker in order for the attacker to be sure that all possible partitions have been attacked. This increases the time needed to successfully complete an attack by a factor of about 200. One or more of the M active partitions can be a secure partitions, each protected by a password.

The number of partitions created by the authorized user are unknown to an unauthorized user since they are not displayed by the operating system to a user without a password. An unauthorized access to all of the data in all of the created partitions requires the passwords for all of the possible partitions, making an attack by an unauthorized user take an excessive length of time.

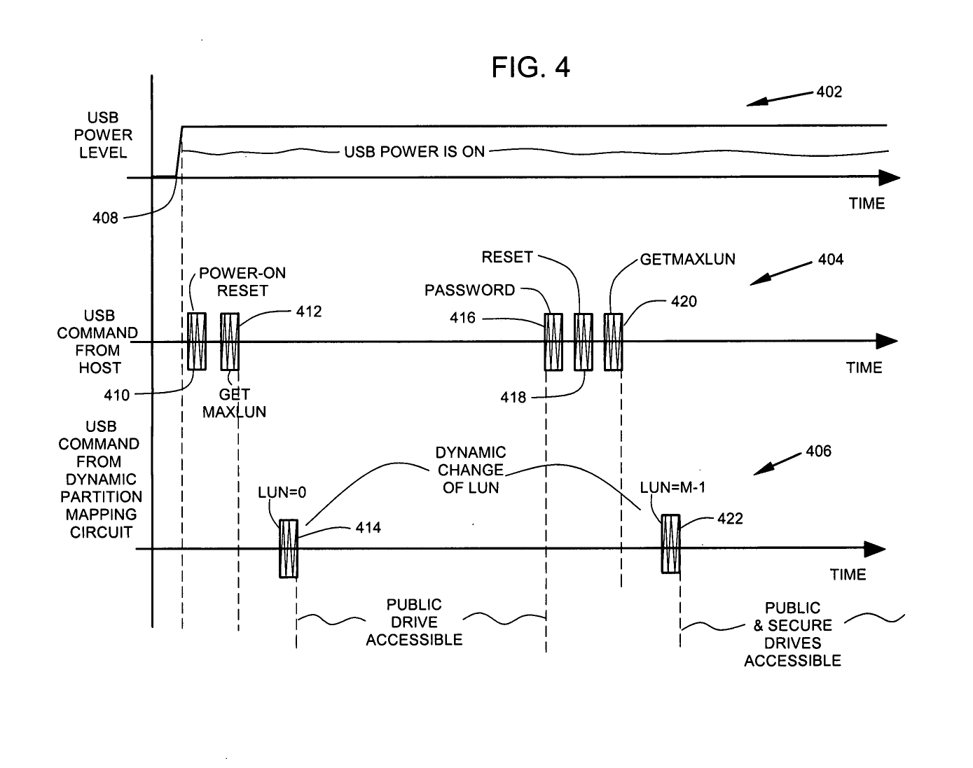

FIG. 4 illustrates a timing diagram of energization activity on the USB power lines at 402 and serial digital communication activity on the USB data lines at 404 and 406. The timing diagram in FIG. 4 is simplified to illustrate timing relationships and does not show bit-by-bit details of each serial communication. Commands on the USB data lines from a host operating system are shown at 404. Commands on the USB data lines from control electronics (such as that shown in FIGS. 2, 3) are shown at 406. The control electronics has a removable USB connector that is plugged in at time 408. The host senses that a new USB device has been plugged in and responds with a power-on reset command 410 and a GetMaxLUN command 412. The sensing of application of power can be sensed directly at the power conductors of the USB bus, or sensed indirectly by sensing a change of DC level on the communication conductors of the USB bus. The control electronics answers back with a command LUN=0 at 414. The user then decides to partition the drive and enters a password. When the partition information and password are entered at the host system, a password command 416 is sent by the host, and then the host also sends a reset command 418, followed by a GetMaxLUN command 420. The control electronics recognizes the reset command 420 was not a power-on reset command because it occurred while the USB power has been on for some time without interruption, and the control electronics recognizes the reset command 420 in the absence of a change of power level to be a simulated unplug and replug of the USB bus. The control electronics dynamically changes the LUN to LUN=1 at 422, and the dynamic change of partition is complete. After the dynamic remapping, there are 2 partitions (corresponding to LUN=0 and LUN=1). The newly created partition can be public or secure according to the user's instructions. It will be understood by those skilled in the art that there can be a DC level and additional “traffic” or “overhead” communication on the USB bus that are not shown, and that the timing diagram in FIG. 4 has been simplified for clarity in describing the overall timing of dynamic partition mapping.

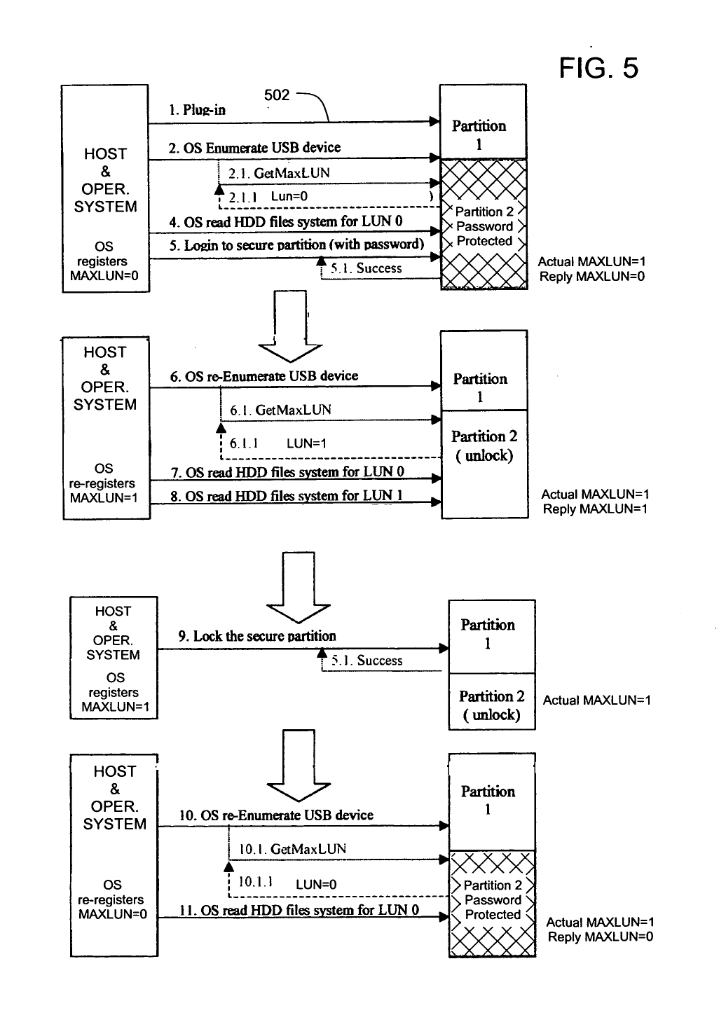

FIG. 5 illustrates an exemplary sequence of communication activity (central lines) over a USB bus between a host operating, system (left hand blocks) and a dynamically partitionable data storage apparatus (right hand blocks) that is connectable and removable by plugging and unplugging of the USB bus.

In FIG. 5 at 502, the data storage apparatus is plugged into the USB bus at step 1. At step 2, the operating system enumerates the partitions of the USB storage apparatus. Step 2 is comparable to commands 410, 412, 414 in FIG. 4. Partition 2 is password protected and hidden, so the operating system does not recognize or display partition 2 at step 4. At step 4, the operating system reads the files (directory structure) of partition 1 only. Next, at step 5, a login password is provided to the secure partition 2. Step 5 is comparable to commands 416 in FIG. 4.

Next, at step 6, the operating system re-enumerates the data storage apparatus. Step 6 is comparable to commands 418, 420, 422. After completion of step 6, the partition 2 is recognized and displayed by the operating system. At step 7, the operating system reads the files (directory structure) for partition 1 (LUN=0). At step 8, the operating system reads the files (directory structure) for partition 2 (LUN=1).

Next, at step 9, the user provides a command to lock the secure partition, and this command is communicated over the USB bus. Next, at step 10, the operating system sends a command to re-enumerate the data storage apparatus, resulting in LUN=0 command at step 10.1.1. At step 11, the operating system again reads files (directory structure) for partition 1 only, and the partition 2 is again hidden and password protected.

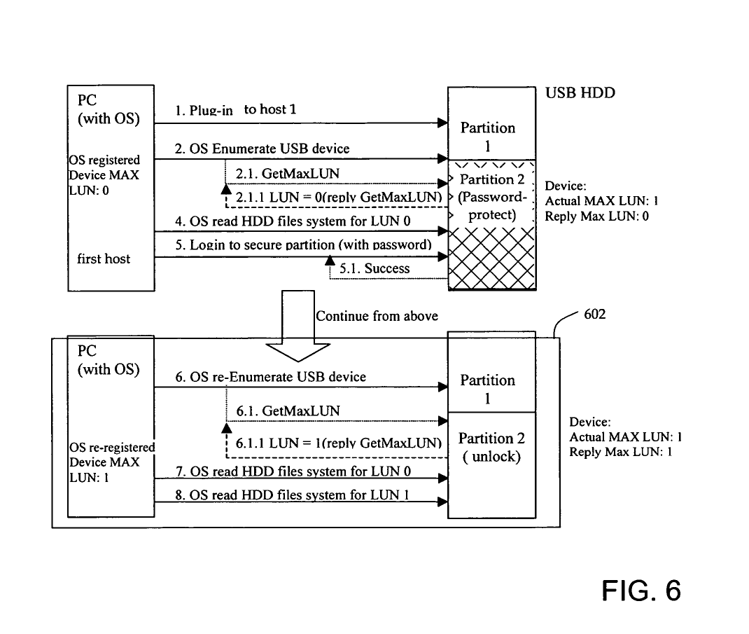

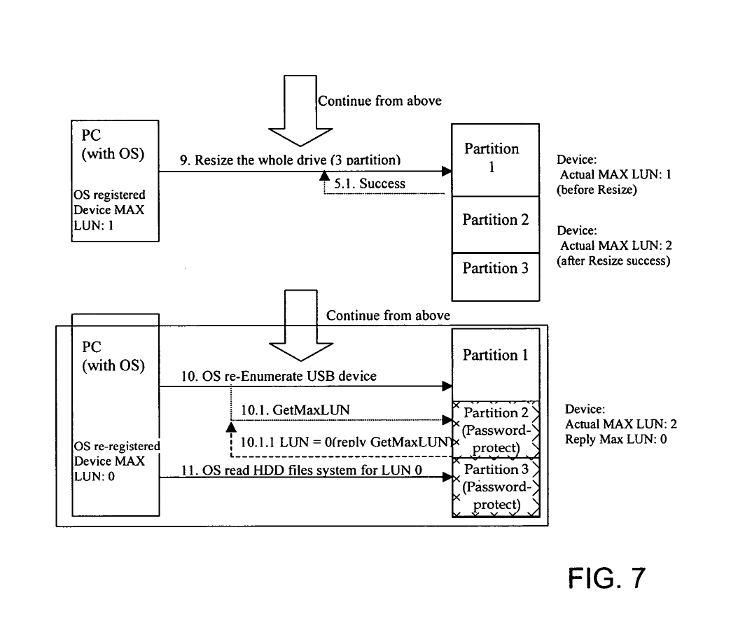

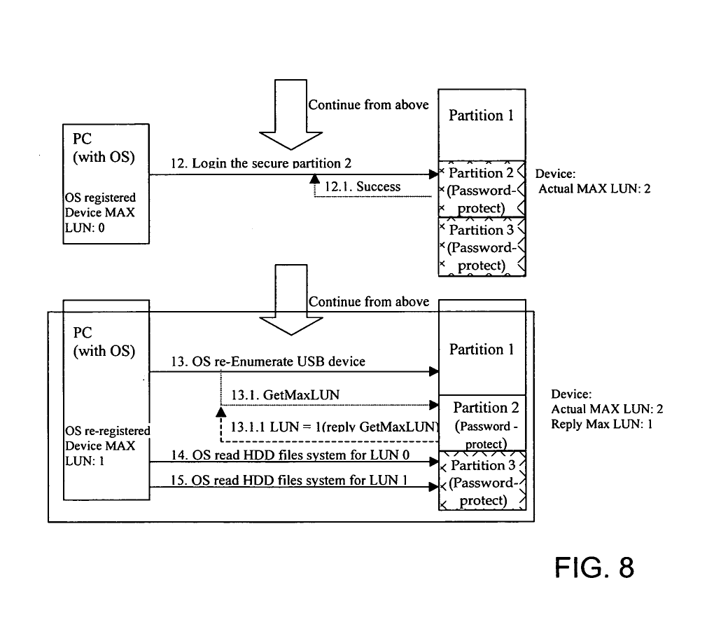

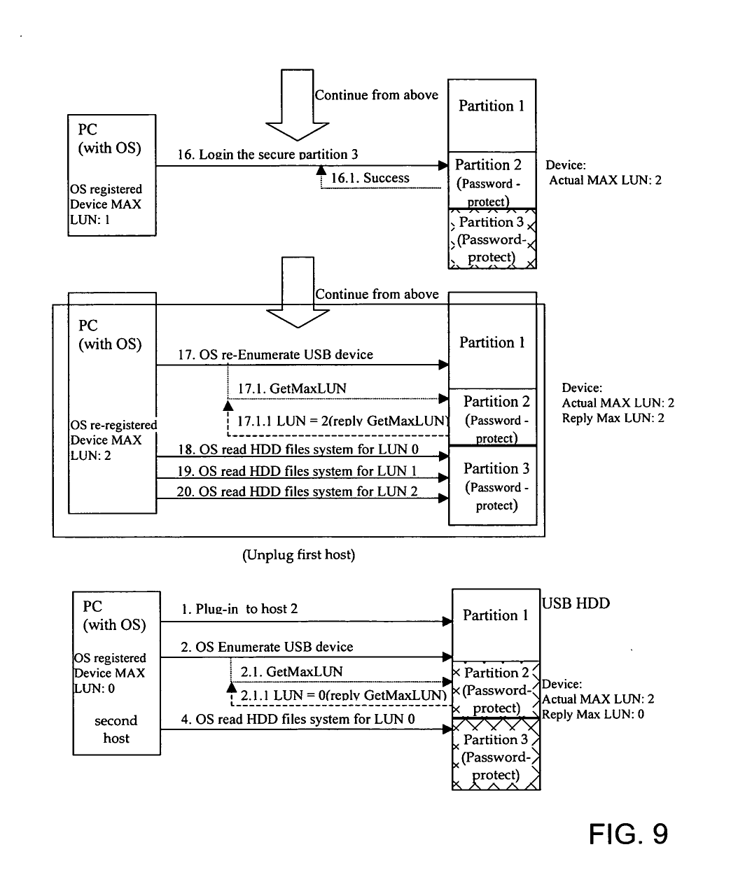

Another example is illustrated in FIGS. 6-9. FIGS. 6-9 illustrate a second sequence of communication activities on a USB bus as a data storage apparatus is plugged into a first host (FIG. 6), the data storage apparatus is resized from two to three partitions (FIG. 7), a login is made to a second partition (FIG. 8), and then the data storage apparatus is unplugged from the first host (FIG. 9) and plugged into a second host (FIG. 9).

FIG. 6 illustrates plug-in of the data storage apparatus to a first host including steps 1-5 that are comparable to steps 1-8 in FIG. 5 as described above. Steps 6-8 in box 602 show the flow for the first host to unlock the secure partition for access.

FIG. 7 illustrates use of the RESIZE command from the first host to resize the data storage apparatus from two partitions (MAXLUN=1) to three partitions (MAXLUN=2) according to the preference of the authorized user. Upon completion of the resizing at step 11, there are three partitions, and partitions 2 and 3 are password protected.

FIG. 8 illustrates the user providing a password on the first host to login to secure partition 2. The operating system in the first host is able to read files for LUN=0 partition 1) at step 14 and LUN=1 (partition 2) at step 15, but is not able to read files for LUN=2 (partition 3).

FIG. 9 illustrates the user providing a password on the first host to login to secure partition 3 at step 16. The operating system in the first host is able to read files for LUN=0 (partition 1) at step 18 and LUN=1 (partition 2) at step 19, and LUN=2 (partition 3) at step 20. After completion of step 20, the first host is unplugged from the data storage apparatus. The unplugging disconnects power from the data storage apparatus, and logins are thereby cancelled in the data storage apparatus.

At step 1 (after step 20) in FIG. 9, the data storage apparatus is plugged into an second host, and partitions 2 (LUN=1) and 3 (LUN=2) are password protected for the connection to the second host. If the user wants to access the secure partitions on host 2, the user can again provide passwords (not illustrated).

When the Actual MAXLUN register in the USB device is 1(2 partition exist), a user can resize and re-create any number of partitions as required. (in this RESIZE case illustrated in FIG. 7 , total of 3 partition is required). The resize command contains information such as number of total partition and secure partitions. Upon received this command, the USB drive will re-reset the actual MAX LUN to 2 (3 partitions). However, a newly created partition will not be immediately accessible to a user on the first host. The reset signal will allow the host to update new partition info.

The embodiments described above are implemented using Universal Serial Bus (USB) communication. Use of a USB implementation of the embodiments rather than one of the many other PC communication protocols provides advantages. The USB host software interfaces with the host computer and there is no need to resolve IRQ line or DMA channel conflicts for each data storage apparatus after dynamic remapping. With the USB interface, there is also no need for adjusting memory or I/O space in the host computer after dynamic remapping. The data storage apparatus can be attached by the USB cable while the host is already running (hot connection) without a need to reboot the host. Data storage apparatuss can be manufactured with various USB speed options, and can be manufactured to go into a USB low power suspended state when they are not in use. The data storage apparatus can also use isosynchronous USB data transfers for audio/video streaming applications.

It will be understood that features in the above described embodiments can be appropriately combined with one another. It will be understood by those skilled in the art that specific time sequences and specific command names are exemplary and that other time sequences and command names can be used to accomplish dynamic partition mapping as set forth above.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the data storage apparatus while maintaining substantially the same functionality without departing from the scope and spirit of the present invention. In addition, although the preferred embodiment described herein is directed to a data storage apparatus including a hard disc drive, it will be appreciated by those skilled in the art that the teachings of the present invention can be applied to other types of data storage media such as ferroelectric data storage drives, and other types of S busses such as Firewire busses, without departing from the scope and spirit of the present invention.

What is claimed is:

1. An apparatus, comprising:
a data storage medium that is partitionable; and
control electronics that includes a hot-pluggable connection with a bus, wherein the control electronics receives a command from a host while the bus is energized, and the control electronics dynamically re-maps the data storage medium to provide a selected number M of active partitions, where the selected number M is dynamically controllable from the host.

2. The apparatus of claim 1 wherein the selected number M is a function of a dynamic logical unit number stored by the control electronics.

3. The apparatus of claim 1 wherein the selected number M is not displayed to the user.

4. The apparatus of claim 1 wherein selected number M is dynamically resettable after receipt of the RESET command and a password while the USB bus is energized.

5. The apparatus of claim 1 wherein the selected number M is settable at least in the range of 1 to 200.

6. The apparatus of claim 5 wherein at least 1 of the selected number M of active partitions are secure partitions, each protected by a password.

7. The apparatus of claim 6 wherein the number of created partitions are unknown to an unauthorized user, and unauthorized access to all of the data in all of the created partitions requires the password for all of the possible partitions, making an attack by an unauthorized user take an excessive length of time.

9. The apparatus of claim 1 wherein the apparatus is energized by power supplied by the bus.

10. The apparatus of claim 1 wherein the data storage medium comprises a hard disc drive.

11. A method of storing data, comprising:
providing a hot-pluggable connection from control electronics to a bus;
dynamically controlling a selected number M of active partitions from a host computer system connected to the bus; and
responding to a reset command during a period of energization of the bus by dynamically remapping the data storage medium to provide a selected number M of active partitions.

12. The method of claim 11 and controlling a dynamic logical unit number as a function of the number M of selected partitions.

13. The method of claim 11 wherein the host computer system does not display the number of selected partitions to a user until a password is supplied by a user.

14. The method of claim 11 wherein the dynamic remapping is in response to a password provided by a user.

15. The method of claim 14 wherein the password is received from the host.

16. The method of claim 14 wherein the password is a biometric scan.

17. The method of claim 11 and setting the selected number M in at least a range of 1 to 200.

18. A host computer system, comprising:
a hot-pluggable bus connection; and
control electronics that provides a soft command to the bus, a get-maximum-logical-unit number command and a password addressed to apparatus connected to the hot-pluggable connection during a period of uninterrupted energization of the apparatus.

19. The host computer of claim 18 wherein the password comprises a password entered by a user.

20. The host computer of claim 18 wherein the password comprises biometric data provided by a user.

21. An apparatus, comprising:
a data storage medium that is partitionable; and
control electronics that includes a connection with a USB bus, wherein the control electronics receives a RESET command from a host while the USB bus is energized, and dynamically re-maps the storage drive to provide a selected number M active partitions where the selected number M is dynamically controllable by the host.

22. The apparatus of claim 21 wherein the selected number M is a function of a dynamic logical unit number stored by the control electronics.

23. The apparatus of claim 21 wherein dynamic setting of the selected number M is resettable after receipt of the RESET command and a password while the USB bus is energized.

24. The apparatus of claim 21 wherein the apparatus is energized by power supplied by the USB bus.

25. The apparatus of claim 21 wherein the apparatus comprises a disc drive.

26. The apparatus of claim 21 wherein the selected number M is limited by the host and is not limited by the control electronics.
